(19) United States
(12) Patent Application Publication
(10) Pub. No.: US 2026/0243286 A1
(43) Pub. Date: Aug. 20, 2026

(54) Coupling Arrangement For Connecting Panels

(71) Applicant: Reuben Andrew George Mills, Victoria (CA)

(72) Inventor: Reuben Andrew George Mills, Victoria (CA)

(21) Appl. No.: 19/056,752

(22) Filed: Feb. 19, 2025

(51) Int. Cl. F16B 5/06

(52) U.S. Cl. CPC F16B 5/0614

(57) ABSTRACT

A method for connecting a first panel [102] to a second panel [104] at a desired angle, by a connection arrangement [200] is provided. The method initiates with cutting a first connector member [300] at a primary diametrical cutting plane, forming a cutting angle with a longitudinal plane parallel to a surface of a middle wall portion of an H-profiled portion of the first connector member [300], wherein the cutting angle is half of the desired angle. The second connector member [400] is cut in a similar manner. Thereafter, the first connector member and the second connector member, are assembled and attached to a cylinder member [500]. The first panel and the second panel are attached to the first connector member [300] and the second connector member [400], respectively, to install the first panel [102] at the desired angle relative to the second panel [104].

### TECHNICAL FIELD

The present disclosure relates to a coupling arrangement for connecting two panels together at a desired angle, and more particularly the present disclosure relates to providing a universal solution of the coupling arrangement that can connect a first panel to a second panel, such that any desired angle can be achieved therebetween by use of same coupling arrangement.

### BACKGROUND

This section is intended to provide information relating to the field of the disclosure and thus, any approach or functionality described below should not be assumed to be qualified as prior art merely by its inclusion in this section.

A variety of industries require connection of two panels at a desired angle. For example, in furniture industry, for manufacturing a furniture cabinet, two panels, i.e. a first wooden panel and a second wooden panel, may require to be connected at a desired angle (for example ‘a right angle’). Similarly, in automobile industry, for manufacturing of a vehicle body panel of a vehicle, two panels, for example a first wall panel and a second roof panel, may require to be connected at a desired angle (for example ‘a right angle’). Moreover, during such connections, a variety of desired angles may require to be achieved between the panels, such as but not limited to, a right angle, a ‘60 degrees’ angle, a ‘30 degrees’ angle, and/or any other angle thereof. For example, in automobile industry, for manufacturing a rear wall of the vehicle body panel of the vehicle, two panels for example a first rear wall panel and a second rear wall panel, may require to be connected together at the desired angle (for example ‘30 degrees’ angle).

A coupling arrangement is considered to be an easy and cost-effective solution for connecting such panels. The coupling arrangement defines cavities to receive at least two panels, for example a first panel and a second panel therein, such that the two panels are oriented at the desired angle upon being received within the coupling arrangement. For connection purposes, the first panel and the second panel are received within the cavities of such coupling arrangement, and is adhesively fixed therein, to be oriented at the desired angle. It may be noted that, conventionally, the desired angle achieved by the coupling arrangement is usually fixed and predefined. Particularly, each coupling arrangement is able to achieve only one desired angle between the first panel and the second panel. Therefore, a different design of the coupling arrangement is required for achieving a different angle between the first panel and the second panel. Therefore, an increased invent tory of the variety of the coupling arrangement is required to be maintained. This substantially increases an inventory cost and thus manufacturing for connection of the first panel and the second panel.

Therefore, there is need to provide a cost-effective and universal coupling arrangement that can connect a first panel to a second panel, such that any desired angle can be achieved therebetween by use of same coupling arrangement.

### SUMMARY OF THE INVENTION

One aspect of the present disclosure relates to a coupling arrangement for connecting a first panel to a second panel at a desired angle. The coupling arrangement comprises a first connector member and a second connector member. Each of the first and second connector member comprises an elongated H-profiled portion and an elongated pipe portion. The elongated H-profiled portion includes opposite facing first and second longitudinal wall and a middle lateral wall. The elongated H-profiled portion defines a panel receiving cavity and a pipe-portion receiving cavity. The elongated pipe portion is positioned within the pipe receiving cavity, while the first and second longitudinal wall and the middle wall are positioned tangential to the elongated pipe portion. One of the first connector member and the second connector member is cut at a primary diametrical cutting plane forming a cutting angle with a longitudinal plane parallel to a surface of the middle lateral wall thereof, such that the cutting angle is half of the desired angle. Similarly, other of the first connector member and the second connector member is cut at a secondary diametrical cutting plane, such that a cut-out sector of the elongated pipe portion of the other of the first connector member and the second connector member forms an imaginary pipe with a cut-out sector of the elongated pipe portion of the one of the first connector member and the second connector member. Further, a cylinder member is circumferentially and snugly positioned within the imaginary pipe formed between the cut-out sector of the elongated pipe portion of the one of the first connector member and the second connector member and the cut-out sector of the elongated pipe portion of the other of the first connector member and the second connector member. Each of the one of the first and second the one of the first and second connector member and the other of the first and second connector member are fixedly attached to the cylinder member. Moreover, the first panel is received within the panel receiving cavity of the one of the first and second connector member, and is fixedly attached to the first and second longitudinal wall and the middle lateral wall of the elongated H-profiled portion of the one of the first and second connector member. Additionally, the second panel is received within the panel receiving cavity of the other of the first and second connector member, and is fixedly attached to the first and second longitudinal wall and the middle lateral wall of the elongated H-profiled portion of the other of the first and second connector member. Thus, the first panel is positioned at the desired angle relative to the second panel.

Another aspect of the present disclosure relates to a method for connecting a first panel to a second panel at a desired angle by a connection arrangement. The connection arrangement includes a first connector member and a second connector member, each of the first and second connector member comprises an elongated H-profiled portion defining a panel receiving cavity and a pipe-portion receiving cavity, and an elongated pipe portion positioned within the pipe receiving cavity, The method initiates with cutting one of the first connector member and the second connector member at a primary diametrical cutting plane, forming a cutting angle with a longitudinal plane parallel to a surface of any of a middle wall portion of the H-profiled portion, wherein the cutting angle is half of the desired angle. The method then proceeds to perform cutting other of the first connector member and the second connector member a secondary diametrical cutting plane, such that a cut-out sector of the elongated pipe portion of the other of the first connector member and the second connector member forms an imaginary pipe with a cut-out sector of the elongated pipe portion of the one of the first connector member and the second connector member. Thereafter, in the method, the one of the first connector member and the second connector member and the other of the first connector member and the second connector member, is assembled with a cylinder member, such that the one of the first connector member and the second connector member and the other of the first connector member and the second connector member are angularly positioned at the desired angle. Lastly, the first panel is attached to the one of the first connector member and the second connector member, and also the second panel is attached to the other of the first connector member and the second connector member, to install the first panel at the desired angle relative to the second panel.

### BRIEF DESCRIPTION OF DRAWINGS

In order to explain the technical solution in the embodiments of the present application more clearly, the drawings used in the description of the embodiments will be briefly introduced below. It is obvious that the drawings in the following description are only some embodiments of the application. For those skilled in the art, without any creative work, other drawings can be obtained based on these drawings.

FIG. 1 illustrates a first connector member of a connector arrangement for connecting a first panel to a second panel at a desired angle, in accordance with the concepts of the present disclosure.

FIG. 2 illustrates the first connector member of FIG. 1, showing a primary cutting plane for cutting the exemplary connector member.

FIG. 3 illustrates a second connector member of the connector arrangement for connecting the first panel to the second panel at the desired angle.

FIG. 4 illustrates the second connector member of FIG. 1, showing a secondary cutting plane for cutting the second connector member.

FIG. 5 illustrates an exploded view of the connector arrangement for connecting the first panel to the second panel at the desired angle.

FIG. 6 illustrates an exploded view of the connector arrangement of FIG. 3, wherein the first connector member is cut along the primary cutting plane. while the second connector member is cut along the secondary cutting plane.

FIG. 7 illustrates an exploded view of the connector arrangement of FIG. 3, wherein the first connector member and the second connector member are positioned to surround a cylinder.

FIG. 8 illustrates an assembled view of the connector arrangement of FIG. 3, wherein first panel and the second panel are assembled with the connector arrangement.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details, or with other methods, components, materials, etc. In other instances, well known structures, materials, or operations are not shown or described in detail to avoid obscuring certain aspects.

Several features described hereafter can each be used independently of one another or with any combination of other features. An individual feature may not address any of the problems discussed above or might address only one of the problems discussed above. Some of the problems discussed above might not be fully addressed by any of the features described herein. Exemplified embodiments of the present disclosure are described below, as illustrated in various drawings in which like reference numerals refer to the same parts throughout the different drawings.

The foregoing disclosure is not intended to limit the present disclosure to the precise forms of particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure.

In the foregoing specification, the disclosure has been described with reference to specific embodiments disclosed herein can be modified or otherwise implemented in various other ways without departing from the spirit and scope of the disclosure. Accordingly, this description is to be considered illustrative and is for the purpose of teaching those skilled in the art the manner of making and using various embodiments of the disclosure. It is to be understood that the forms of the disclosure herein shown and described are to be taken as representative embodiments. Equivalent elements, materials processed or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, and “is”, used to describe and claim the present disclosure are intended to be construed in a non-exclusive manner, namely allowing for items, components, or elements not explicitly described also to be present.

Further, various embodiments disclosed herein are to be taken in the illustrative and explanatory sense, and would in no way be construed as limiting the present disclosure. All joinder references (e.g., attached, affixed, coupled, connected, etc.) are only used to aid the reader's understanding of the present disclosure, and may not create limitations, particularly as to the position orientation, or use of the system and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “primary”, “secondary”, “main” or any other ordinary and/or numerical terms, should also be taken as identifiers, to assist the reader's understanding of the various elements, embodiments, variations and/or modifications of the present disclosure, and may not create any limitations, particularly as to the order, or preference, of any element, embodiment, variation, and/or modification relative to, or over, another element, embodiment, variation and/or modification.

It will also be appreciated that one or more of the elements depicted in the drawings/figures can also be implemented in a more separated or integrated manner, or even removed, or rendered as inoperable in certain cases, as is useful in accordance with a particular application. The embodiments of the present disclosure will now be described in detail with reference to the accompanying drawings. However, the disclosed disclosure is not limited to the present embodiments.

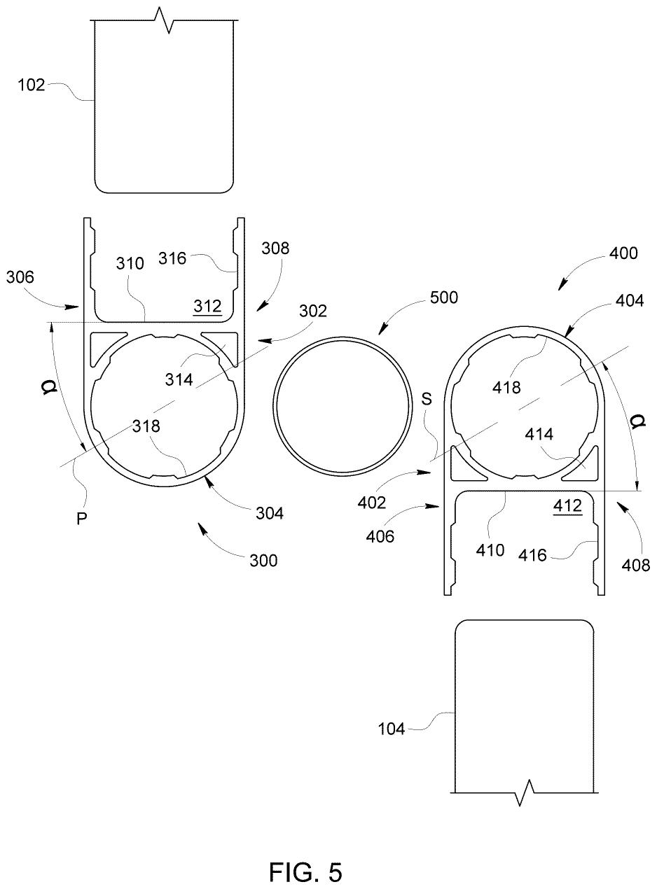

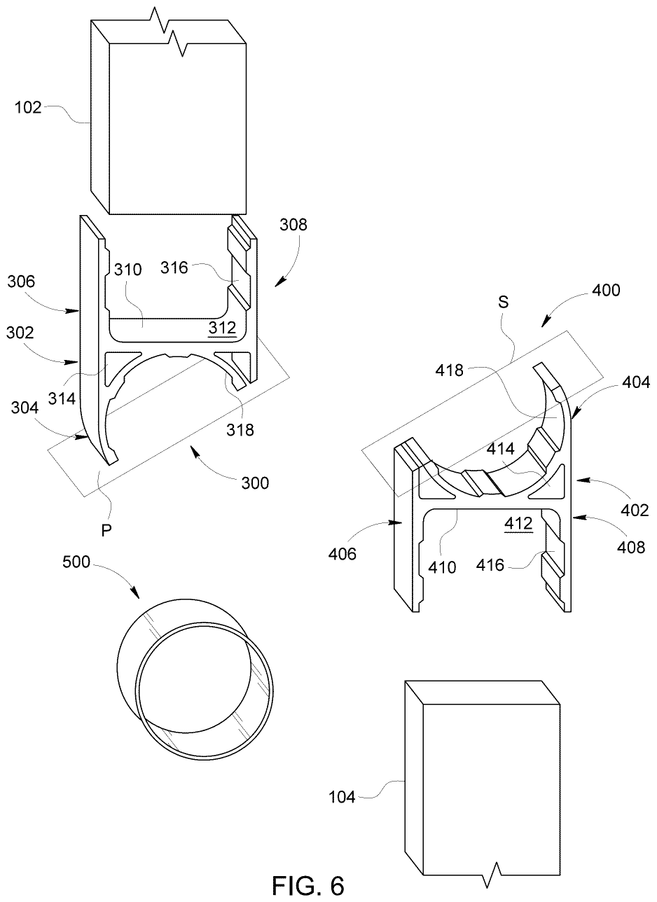

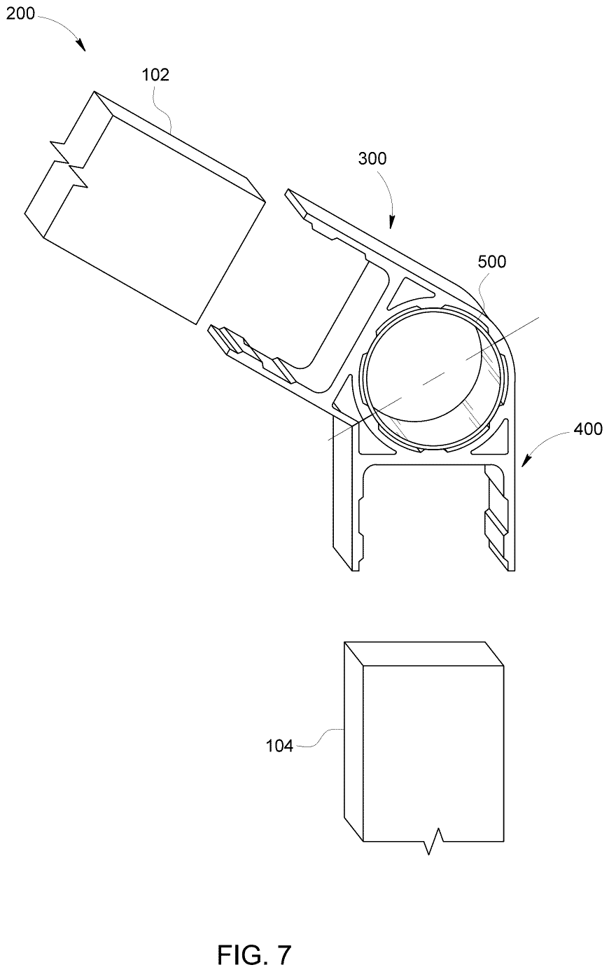

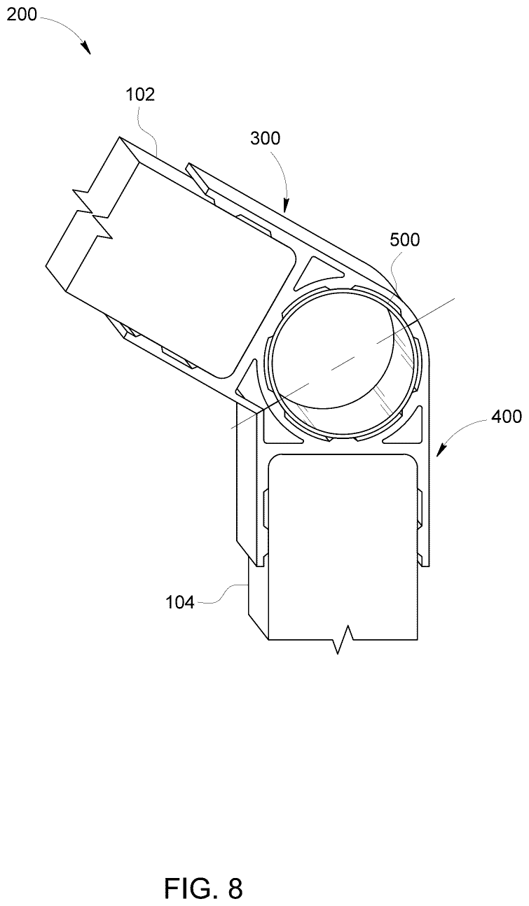

Referring to FIG. 5 to 8, there is shown a connector arrangement [200] for connecting a first panel [102] to a second panel [104] at a desired angle. It may be noted that the first panel [102] and the second panel [104] are elongated panels made up of different materials including, such as but not limited to, wooden plank panel, metal sheet panel, plastic panels, and the like. Moreover, a connection between the first panel [102] and the second panel [104] may be required for manufacturing of a final product in a variety of industries. For example, in a furniture industry, for manufacturing a furniture cabinet, two panels are deployed, i.e. the first panel [102] namely a first wooden plank panel and the second panel [104] namely a second wooden panel, which may require to be connected at a desired angle (for example ‘a right angle’). Therefore, a material or structure of the first panel [102] and the second panel [104] does not limit the scope of the present disclosure and any material or shape known to a person skilled in the art is within a scope of the present disclosure. Similarly, in automobile industry, for manufacturing of a vehicle body panel of a vehicle, two panels are deployed, i.e. the first panel [102] namely a first metal sheet floor panel and the second panel [104] namely a second metal sheet roof panel, which may require to be connected at a desired angle (for example ‘a right angle’). Another such example in the automobile industry is, for manufacturing a rear wall of the vehicle body panel of the vehicle, two panels are deployed, i.e. the first panel namely a first rear wall sheet metal panel and a second rear wall sheet metal panel, which may require to be connected together at the desired angle (for example ‘30 degrees’angle). Therefore, the connection of the first panel [102] and the second panel [104], for manufacturing of a variety of products in a variety of industries, is within a scope of the present disclosure.

Furthermore, the connection arrangement [200] is provided to connect the first panel [102] and the second panel [104] at the desired angle. In the present disclosure, the connection arrangement [200] is provided, such that any desired angle between the first panel [102] and the second panel [104] can be achieved by the same connection arrangement [200]. The connection arrangement [200] includes a first connector member [300], a second connector member [400], and a cylinder [500]. Particularly, each of the first connector member [300] and the second connector member [400] of the connection arrangement [200], are suitably structured and arranged, such that any desired angle can be achieved between the first panel [102] to the second panel [104]. For ease in reference and understanding, a structure and arrangement of each of the first connector member [300] and the second connector member [400], will be discussed in detail hereinafter. It may be noted that each of the first connector member [300] and the second connector member [400] are identical in structure and arrangement.

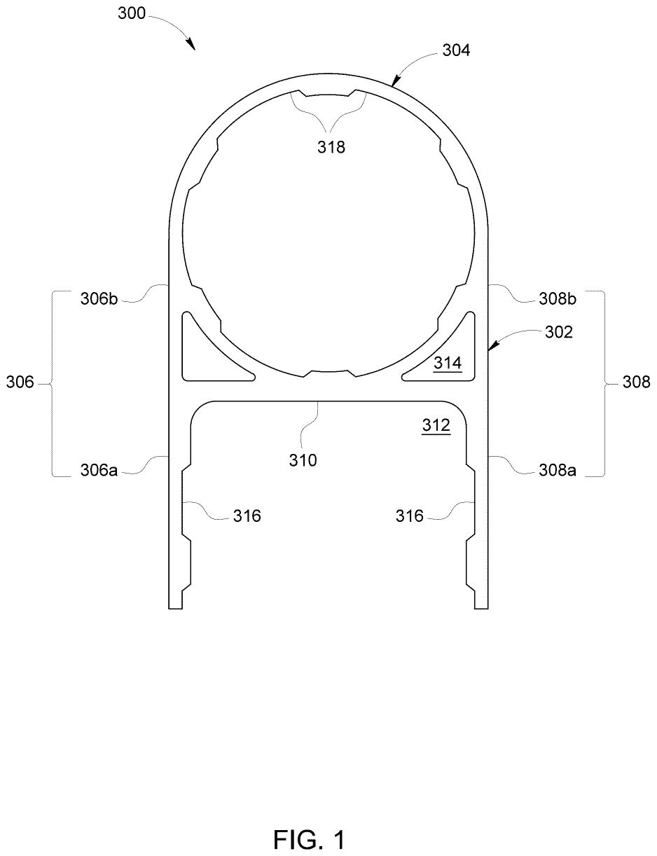

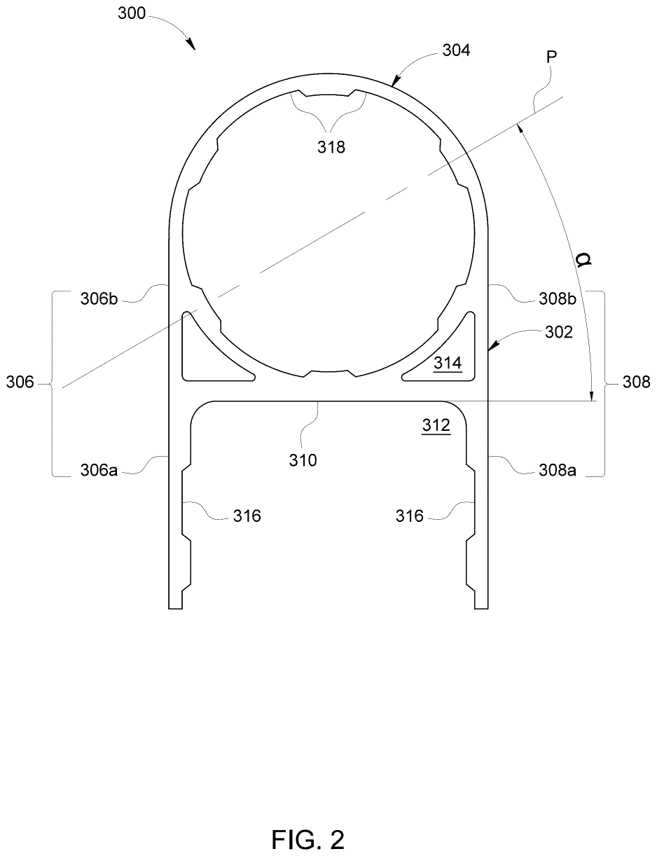

Referring to FIGS. 1 and 2, there is shown a side view of the first connector member [300]. The first connector member [300] includes an elongated H-profiled portion [302] and an elongated pipe portion [304].

The H-profiled portion [302] includes opposite facing first and second longitudinal walls [306, 308] and a middle lateral wall [310], while defining a panel receiving cavity [312] and a pipe-portion receiving cavity [314]. Notably, the panel receiving cavity [312] and the pipe-portion receiving cavity [314] are separated by the middle lateral wall [310] thereof. Specifically, each of the first and second longitudinal wall portions [306, 308] define a panel-facing half section [306a, 308a] and a panel-opposing half section [306b, 308b], such that the panel receiving cavity [312] is defined between the panel-facing half sections [306a, 308a] of the first and second longitudinal wall portions [306, 308], while the pipe-portion receiving cavity [314] is defined between the panel-opposing half sections [306b, 308b] of the first and second longitudinal wall portions [306, 308]. Further, it may be noted that each of the first and second longitudinal walls [306, 308] and the middle lateral wall [310] includes a panel panel-facing surface and a panel-opposing surface, such that panel panel-facing surface of each of the first and second longitudinal walls [306, 308] and the middle lateral wall [310] includes a flat stepped region defining a plurality of flat ribs [316] therein.

The elongated pipe portion [304] is integrally formed with the elongated H-profiled member [302]. The elongated pipe portion [304] is positioned within the pipe receiving cavity [314], while the first and second longitudinal walls [306, 308] and the middle wall [310] are positioned tangential to the elongated pipe portion [304]. Notably, an inner circumferential surface of the elongated pipe portion [304] includes a curved stepped region that defines a plurality of curved ribs [318] therein. Furthermore, in an embodiment a side surface of the elongated pipe portion [304] defines angular indentations, wherein each angular indentation corresponds to a cutting angle of a primary diametrical cutting plane at which the first connector member [300] can be cut, which will be explained in details later in the present disclosure.

In accordance with the present disclosure, as is shown in FIG. 2, the first connector member [300] is cut at the primary diametrical cutting plane (P), forming a cutting angle (a) with a longitudinal plane (L) parallel to a surface of the middle wall portion [310] of the H-profiled portion [302], wherein the cutting angle is half of the desired angle. Details of the same will be explained later in details.

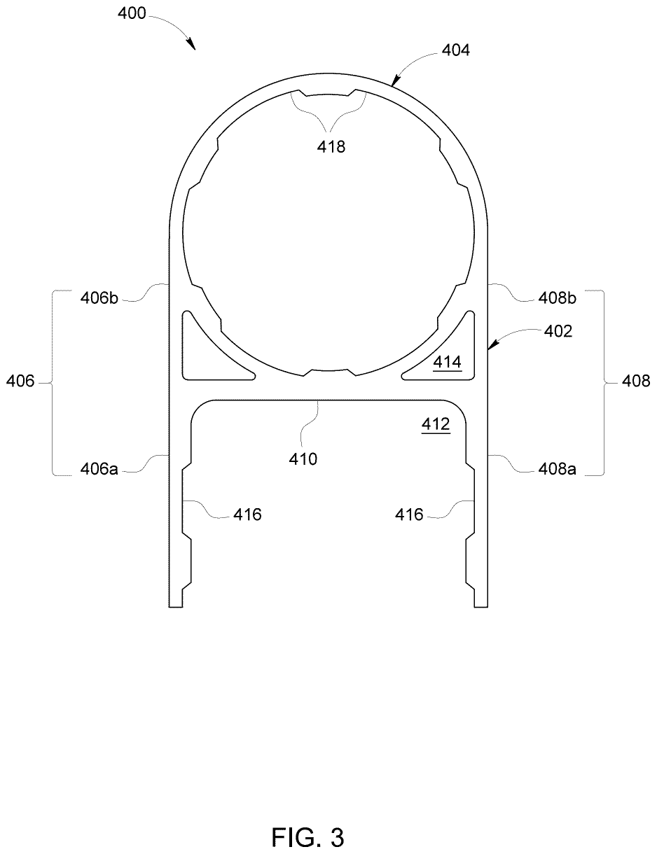

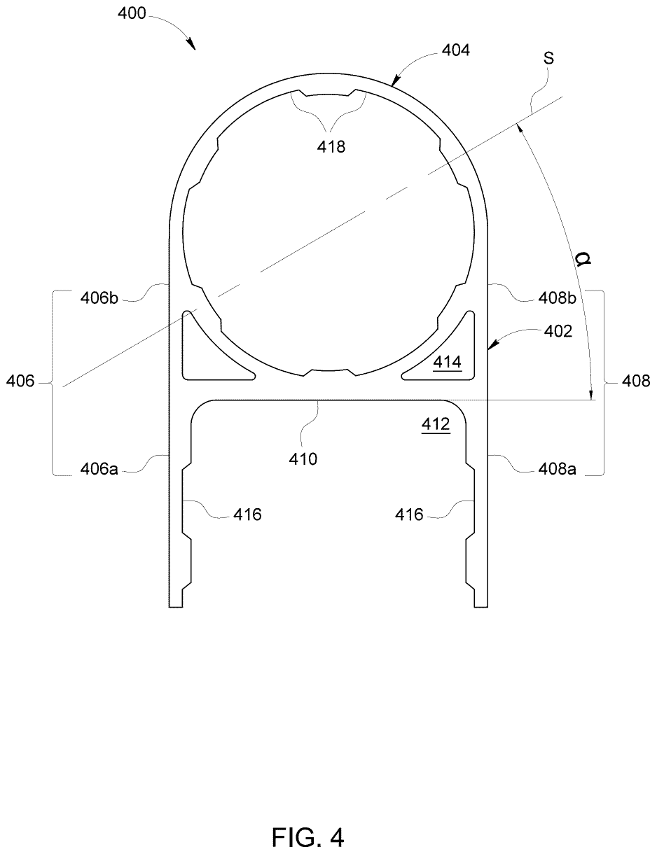

Referring to FIGS. 3 and 4, there is shown a side view of the second connector member [400]. The second connector member [400] includes an elongated H-profiled portion [402] and an elongated pipe portion [404].

The H-profiled portion [402] includes opposite facing first and second longitudinal walls [406, 408] and a middle lateral wall [410], while defining a panel receiving cavity [412] and a pipe-portion receiving cavity [414]. Notably, the panel receiving cavity [412] and the pipe-portion receiving cavity [414] are separated by the middle lateral wall [410] thereof. Specifically, each of the first and second longitudinal wall portions [406, 408] define a panel-facing half section [406a, 408a] and a panel-opposing half section [406b, 408b], such that the panel receiving cavity [412] is defined between the panel-facing half sections [406a, 408a] of the first and second longitudinal wall portions [406, 408], while the pipe-portion receiving cavity [414] is defined between the panel-opposing half sections [406b, 408b] of the first and second longitudinal wall portions [406, 408]. Further, it may be noted that each of the first and second longitudinal walls [406, 408] and the middle lateral wall [410] includes a panel panel-facing surface and a panel-opposing surface, such that panel panel-facing surface of each of the first and second longitudinal walls [406, 408] and the middle lateral wall [410] includes a flat stepped region defining a plurality of flat ribs [416] therein.

The elongated pipe portion [404] is integrally formed with the elongated H-profiled member [402]. The elongated pipe portion [404] is positioned within the pipe receiving cavity [414], while the first and second longitudinal walls [406, 408] and the middle wall [410] are positioned tangential to the elongated pipe portion [404]. Notably, an inner circumferential surface of the elongated pipe portion [404] includes a curved stepped region that defines a plurality of curved ribs [418] therein. Furthermore, in an embodiment a side surface of the elongated pipe portion [404] defines angular indentations, wherein each angular indentation corresponds to a cutting angle of a secondary diametrical cutting plane at which the second connector member [400] can be cut, which will be explained in details later in the present disclosure.

In accordance with the present disclosure, as is shown in FIG. 4, the second connector member [400] is cut at the secondary diametrical cutting plane(S), such that a cut-out sector of the elongated pipe portion [404] of the second connector member [400] forms an imaginary pipe with a cut-out sector of the elongated pipe portion [304] of the first connector member [300]. Details of the same will be explained later in details.

Referring back to FIG. 5 to 8, there is shown the connector arrangement [200], for the purpose of describing an assembly of the connector arrangement, and further a method of connecting the first panel [102] to the second panel [104] at the desired angle, by use of the connector arrangement [200]. As is already mentioned, the connector arrangement includes the first connector member [300] and the second connector member [400] of the aforementioned structure and arrangement, and additionally includes a cylinder member [500]. Therefore, a structure and arrangement of the cylinder member [500] will now be described in details.

The cylinder member [500] can be any of a hollow pipe member or a solid cylinder member. However, in a preferred embodiment, the cylinder member [500] is the solid cylinder member, for providing strength to the overall connection arrangement [200]. Notably, the cylinder member [500] circumferentially and snugly positioned within the imaginary pipe formed between the cut-out sector of the elongated pipe portion [404] of the second connector member [400] and the cut-out sector of the elongated pipe portion [304] of the first connector member [300]. Notably, each of the first connector member [300] and the second connector member [400] are fixedly attached to the cylinder member [500]. Details of the attachment will be explained in details hereinafter.

A method for connecting the first panel [102] to the second panel [104] at the desired angle, by use of the connection arrangement [200], will now be described in details hereinafter. The method initiates with cutting one of the first connector member [300] and the second connector member [400] at a primary diametrical cutting plane (P), forming a cutting angle (a) with a longitudinal plane parallel (L) to a surface of the middle wall portion [310, 410] of the H-profiled portion [302, 402], wherein the cutting angle is half of the desired angle. Similarly, the method then performs cutting other of the first connector member [300] and the second connector member [400] at a secondary diametrical cutting plane(S), such that the cut-out sector of the elongated pipe portion [304, 404] of the other of the first connector member [300] and the second connector member [400] forms the imaginary pipe with the cut-out sector of the elongated pipe portion [304, 404] of the one of the first connector member [300] and the second connector member [400]. For the purpose of clarity of the present disclosure, the concepts of the present disclosure will be described, wherein the first connector member [300] is cut at the primary diametrical cutting plane (P), while the second connector member [400] is cut at the secondary diametrical cutting plane(S). It may be obvious to a person skilled in the art that the concepts of the present disclosure also encompasses that wherein the second connector member [400] is cut at the primary diametrical cutting plane (P), while the first connector member [300] is cut at the secondary diametrical cutting plane(S). Accordingly, in the present disclosure, the method initiates with cutting the first connector member [300] at the primary diametrical cutting plane (P) (as is shown in FIG. 2), forming the cutting angle (a) with a longitudinal plane parallel (L) to a surface of the middle wall portion [310] of the H-profiled portion [302], wherein the cutting angle is half of the desired angle to be achieved between the first panel [102] and the second panel [104]. The method further proceeds to perform cutting of the cutting of the second connector member [400] at the secondary diametrical cutting plane(S) (as is shown in FIG. 4), such that the cut-out sector of the elongated pipe portion [404] of the second connector member [400] forms the imaginary pipe with the cut-out sector of the elongated pipe portion [304] of the first connector member [300].

The method then proceeds to assemble the first connector member [300] and the second connector member [400], with the cylinder member [500], such that the first connector member [300] and the second connector member [400] are angularly positioned at the desired angle to be achieved between the first panel [102] and the second panel [104]. Notably, the imaginary pipe is formed between the cut-out sector of the elongated pipe portion [404] of the second connector member [400] and the cut-out sector of the elongated pipe portion [304] of the first connector member [300], wherein the cylinder member [500] is positioned. It may be noted that this step of assembling the first connector member [300] and the second connector member [400], with the cylinder member [500] is performed by sub-steps of: a) circumferentially and snugly positioning the first connector member [300] and the second connector member and the other of the first connector member and the second connector member, over the cylinder member [500], such that the cutout of the first connector member [300] and the second connector member [400] completely encovers the cylinder member [500]; and b) adhesively attaching the first connector member [300] and the second connector member [400], to the cylinder member [500]. It may be noted that the adhesive attachment of each of the first connector member [300] and the second connector member [400], to the cylinder member [500], can be achieved by: i) filling a gap between the plurality of curved ribs [318, 418] defined in the elongated pipe portions [304, 404] of the each of the first connector member [300] and the second connector members [400], and the cylinder member [500], with an adhesive; and ii) thus allowing the adhesive to cure.

Thereafter, the method then proceeds to assemble the first panel [102] to the first connector member [300], and further assemble the second panel [104] to the second connector member [400], to install the first panel [102] at the desired angle relative to the second panel [104]. It may be noted that this step of assembling the first panel [102] and the second panel [104], with the the first connector member [300] and the second connector member [400], respectively, is performed by sub-steps of: a) slidingly positioning the first panel [102] within the panel receiving cavity [312] of the first connector member [300], and slidingly positioning the second panel [104] within the panel receiving cavity [412] of the second connector member [400]; b) adhesively attaching the first panel [102] to the first connector member [300], and adhesively attaching the second panel [104] to the second connector member [400]. It may be noted that the adhesive attachment of the first panel [102] and the second panel [104], to the first connector member [300] and the second connector member [400], respectively, can be achieved by: i) filling a gap between the plurality of flat ribs [316, 416] defined in the elongated H-profiled portion of the one of the first connector member [300] and the second connector members [400], and the first panel [102] and the second panel [104], respectively, with an adhesive; and ii) allowing the adhesive to cure.

Various advantages of the coupling arrangement [200] can be envisioned. One such advantage relates to the flexibility of achieving the desired angle between the first panel [102] and the second panel [104]. Particularly, a variety of desired angle can be achieved by the coupling arrangement [200] of the present disclosure. This will be described in details in the paragraphs to follow.

In an exemplary embodiment of the connection arrangement [200], the desired angle to be achieved between the first panel [102] and the second panel [104] is 60 degrees. In such requirement, the first connector member [300] can be cut along the primary diametrical cutting plane (P, such that the angle (a) between the primary diametrical cutting plane (P) and the longitudinal plane parallel (L) parallel to a surface of the middle wall portion [310] of the H-profiled portion [302], is 30 degrees. Further, in such requirements, the second connector member [400] is cut at the secondary diametrical cutting plane(S), such that the cut-out sector of the elongated pipe portion [404] of the second connector member [400] forms the imaginary pipe with the cut-out sector of the elongated pipe portion [304] of the first connector member [300]. Thereafter, the first connector member [300], the second connector member [400], and the cylinder [500] are assembled together, such that the cylinder [500] is positioned within and attached to the imaginary pipe formed between the cut-out sector of the elongated pipe portion [404] of the second connector member [400] and the cut-out sector of the elongated pipe portion [304] of the first connector member [300]. With such arrangement, the first connector member [300] and the second connector member [400] are positioned at an angle of 60 degrees. Thereafter, the first panel [102] and the second panel [104], are received within and attached to, the panel receiving cavities [312, 412] of the first connector member [300] and the second connector member [400], respectively.

Similarly, in another exemplary embodiment of the connection arrangement [200], the desired angle to be achieved between the first panel [102] and the second panel [104] is 90 degrees. In such requirement, the first connector member [300] can be cut along the primary diametrical cutting plane (P, such that the cutting angle (a) between the primary diametrical cutting plane (P) and the longitudinal plane parallel (L) parallel to a surface of the middle wall portion [310] of the H-profiled portion [302], is 45 degrees. Further, in such requirements, the second connector member [400] is cut at the secondary diametrical cutting plane(S), such that the cut-out sector of the elongated pipe portion [404] of the second connector member [400] forms the imaginary pipe with the cut-out sector of the elongated pipe portion [304] of the first connector member [300]. Thereafter, the first connector member [300], the second connector member [400], and the cylinder [500] are assembled together, such that the cylinder [500] is positioned within and attached to the imaginary pipe formed between the cut-out sector of the elongated pipe portion [404] of the second connector member [400] and the cut-out sector of the elongated pipe portion [304] of the first connector member [300]. With such arrangement, the first connector member [300] and the second connector member [400] are positioned at an angle of 90 degrees. Thereafter, the first panel [102] and the second panel [104], are received within and attached to, the panel receiving cavities [312, 412] of the first connector member [300] and the second connector member [400], respectively.

From the above two embodiments of the connection arrangement [200], it is clear that the desired angle to be achieved between the first panel [102] and the second panel [104], is dependent on the cutting angle (a) of cutting the first connector member [300], and the cutting angle (b) of cutting the second connector member [300]. Since, these cutting angles are user-dependent and can be controlled, same coupling arrangement [200] can be used to achieve a variety of desired angles between the first panel [102] and the second panel [104]. Therefore, it eliminates a need of keeping an inventory of different connection arrangements [200], for achieving different desired angles between the first panel [102] and the second panel [104], thereby reducing an inventory cost and thus manufacturing cost of the final product so achieved. Moreover, this solution of the connection arrangement [200] provides a relatively easy and less complex arrangement of the connection arrangement [200], for achieving the solution of universal connection arrangement [200].

While the present disclosure has been shown and described with reference to the foregoing preferred embodiments, it will be apparent to those skilled in the art that changes in form, connection, and detail may be made therein without departing from the spirit and scope of the disclosure. While the preferred embodiments of the present disclosure have been described hereinabove, it should be understood that various changes, adaptations, and modifications may be made therein without departing from the spirit of the disclosure and the scope of the appended claims. It will be obvious to a person skilled in the art that the present disclosure may be embodied in other specific forms without departing from its spirit or essential characteristics. The described embodiments are to be considered in all respects only as illustrative and not restrictive.

This written description uses examples to provide details on the disclosure, including the best mode, and also to enable any person skilled in the art to practice the disclosure, including making and using any devices or systems and performing any incorporated methods. The patentable scope of the disclosure is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

It is to be understood that the aspects of the embodiments are not necessarily limited to the features described herein. Many modifications and variations of the present subject matter are possible in light of the above disclosure.

I claim:

1. A coupling arrangement for connecting a first panel to a second panel at a desired angle, the coupling arrangement comprising:
a first connector member and a second connector member, each of the first and second connector member comprising:
an elongated H-profiled portion including opposite facing first and second longitudinal wall and a middle lateral wall, while defining a panel receiving cavity and a pipe-portion receiving cavity;
an elongated pipe portion positioned within the pipe receiving cavity, while the first and second longitudinal wall and the middle wall are positioned tangential to the elongated pipe portion; and
wherein one of the first connector member and the second connector member is cut at a primary diametrical cutting plane forming a cutting angle with a longitudinal plane parallel to a surface of the middle lateral wall thereof, such that the cutting angle is half of the desired angle, for connecting the first panel to the second panel at the desired angle.

2. The coupling arrangement as claimed in claim 1, wherein other of the first connector member and the second connector member is cut at a secondary diametrical cutting plane, such that a cut-out sector of the elongated pipe portion of the other of the first connector member and the second connector member forms an imaginary pipe with a cut-out sector of the elongated pipe portion of the one of the first connector member and the second connector member.

3. The coupling arrangement as claimed in claim 2, wherein the primary diametrical cutting plane and the secondary diametrical cutting plane extends along a diameter of the elongated pipe portions of the one of the first connector member and the second connector member and the other of the first connector member and the second connector member, respectively.

4. The coupling arrangement as claimed in claim 2, comprises a cylinder member circumferentially and snugly positioned within the imaginary pipe formed between the cut-out sector of the elongated pipe portion of the one of the first connector member and the second connector member and the cut-out sector of the elongated pipe portion of the other of the first connector member and the second connector member.

5. The coupling arrangement as claimed in claim 1, wherein a panel-facing surface of the first and second longitudinal wall and the middle lateral wall of the elongated H-profiled portion includes a flat stepped region defining a plurality of flat ribs therein.

6. The coupling arrangement as claimed in claim 1, wherein an inner circumferential surface of the elongated pipe portion defines a curved stepped region defining a plurality of curved ribs therein.

7. The coupling arrangement as claimed in claim 4, wherein each of the one of the first and second connector member and the other of the first and second connector member are fixedly attached to the cylinder member, by an adhesive attachment.

8. The coupling arrangement as claimed in claim 1, wherein the first panel is received within the panel receiving cavity of the one of the first and second connector member, and is fixedly attached to the first and second longitudinal wall and the middle lateral wall of the elongated H-profiled portion of the one of the first and second connector member by an adhesive attachment.

9. The coupling arrangement as claimed in claim 1, wherein the second panel is received within the panel receiving cavity of the other of the first and second connector member, and is fixedly attached to the first and second longitudinal wall and the middle lateral wall of the elongated H-profiled portion of the other of the first and second connector member by an adhesive attachment.

10. The coupling arrangement as claimed in claim 1, wherein the panel receiving cavity and the pipe-portion receiving cavity are separated by the middle lateral wall of the elongated H-profiled portion.

11. The coupling arrangement as claimed in claim 1, wherein each of the first and second longitudinal wall portions define a panel-facing half section and a panel-opposing half section, such that the panel receiving cavity is defined between the panel-facing half sections of the first and second longitudinal wall portions, while the pipe-portion receiving cavity is defined between the panel-opposing half sections of the first and second longitudinal wall portions.

12. The coupling arrangement as claimed in claim 1, wherein the elongated pipe portion is integrally formed with the elongated H-profiled member.

13. The coupling arrangement as claimed in claim 1, wherein a side surface of the elongated pipe portion defines angular indentations, wherein each angular indentation corresponds to the cutting angle of the primary diametrical cutting plane and the secondary diametrical cutting plane.

14. A method for connecting a first panel to a second panel at a desired angle by a connecting arrangement, the connecting arrangement includes a first connector member and a second connector member, each of the first and second connector member comprising an elongated H-profiled portion defining a panel receiving cavity and a pipe-portion receiving cavity, and an elongated pipe portion positioned within the pipe receiving cavity, the method comprising:
cutting one of the first connector member and the second connector member at a primary diametrical cutting plane, forming a cutting angle with a longitudinal plane parallel to a surface of the middle wall portion of the H-profiled portion, wherein the cutting angle is half of the desired angle;
cutting other of the first connector member and the second connector member a secondary diametrical cutting plane, such that a cut-out sector of the elongated pipe portion of the other of the first connector member and the second connector member forms an imaginary pipe with a cut-out sector of the elongated pipe portion of the one of the first connector member and the second connector member;
assembling the one of the first connector member and the second connector member and the other of the first connector member and the second connector member, with a cylinder member, such that the one of the first connector member and the second connector member and the other of the first connector member and the second connector member are angularly positioned at the desired angle; and
assembling the first panel to the one of the first connector member and the second connector member, and assemble the second panel to the other of the first connector member and the second connector member, to install the first panel at the desired angle relative to the second panel.

15. The method as claimed in claim 14, wherein the step of assembling the one of the first connector member and the second connector member and the other of the first connector member and the second connector member, with a cylinder member comprises:
circumferentially and snugly positioning the one of the first connector member and the second connector member and the other of the first connector member and the second connector member, over the cylinder member, such that a cut-out of the one of the first connector member and the second connector member and the other of the first connector member and the second connector member completely encovers the cylinder member; and
adhesively attaching the first connector member and the second connector member and the other of the first connector member and the second connector member, to the cylinder member.

16. The method as claimed in claim 14, wherein the step of assembling the first panel and the second panel, respectively to the one of the first connector member and the second connector member, and the other of the first connector member and the second connector member, comprises:
slidingly positioning the first panel within the panel receiving cavity of the first connector member, and slidingly positioning the second panel within the panel receiving cavity of the second connector member;
adhesively attaching the first panel to the first connector member, and adhesively attaching the second panel to the second connector member.

17. The method as claimed in claim 15, wherein the step of adhesively attaching the first connector member and the second connector member and the other of the first connector member and the second connector member, to the cylinder member includes:
filling a gap between a plurality of curved ribs defined in the elongated pipe portions of the each of the one of the first and second connector members, and the cylinder member, with an adhesive; and
allowing the adhesive to cure.

18. The method as claimed in claim 16, wherein the step of adhesively attaching the first panel to the first connector member, and adhesively attaching the second panel to the second connector member, includes:
filling a gap between a plurality of flat ribs defined in the elongated H-profiled portion of each of the one of the first and second connector members, and the cylinder member, with an adhesive; and
allowing the adhesive to cure.

19. The coupling arrangement as claimed in claim 14, wherein the primary diametrical cutting plane and the secondary diametrical cutting plane extends along a diameter of the elongated pipe portions of the one of the first connector member and the second connector member and the other of the first connector member and the second connector member, respectively.
